(19) United States
(12) Patent Application Publication
(10) Pub. No.: US 2014/0137693 A1
(43) Pub. Date: May 22, 2014

(54) ON CENTER RAKE AND TELESCOPE CLAMP FOR AN ADJUSTABLE STEERING COLUMN

(71) Applicants: Donald A. Buzzard, Saginaw, MI (US); Melvin Lee Tinnin, Clio, MI (US)

(72) Inventors: Donald A. Buzzard, Saginaw, MI (US); Melvin Lee Tinnin, Clio, MI (US)

(21) Appl. No.: 13/680,760

(22) Filed: Nov. 19, 2012

(51) Int. Cl. B62D 1/184

(52) U.S. Cl. CPC B62D 1/184
USPC 74/493

(57) ABSTRACT

An adjustable steering column is provided. The steering column includes a rake bracket having first and second legs, a steering shaft extending within an upper jacket along a first axis between the first and second legs, a lower jacket positioned about the upper jacket and a locking clamp positioned about the lower jacket. The steering column further includes an actuating lever rotatable in first and second directions, a clamp bolt having a first end with the actuating lever positioned thereon and a second end coupled to the locking clamp, the clamp bolt extending along a second axis that intersects the upper jacket, and a pressing mechanism positioned on the clamp bolt and operable in response to rotation of the actuating lever such that the steering shaft is secured against adjustment in rake and telescope directions in response to rotation in the first direction and is adjustable in the rake and telescope directions in response to rotation in the second direction.

### BACKGROUND OF THE INVENTION

The following description relates to an adjustable steering column, and in particular an adjustable steering column having an on center rake and telescope clamp.

Adjustable steering columns may be adjustable in a rake direction and a telescope direction. A traditional adjustable steering column includes a clamping mechanism that is actuatable between a clamped position where adjustment of a steering shaft is prevented and an unclamped position where adjustment of the steering shaft allowed. Typically, the clamping mechanism is actuated between clamped and unclamped positions by rotation of a lever.

In traditional adjustable steering columns, a bolt and lever extend along an axis that is spaced from the steering shaft so that the bolt may extend completely across a rake bracket without interfering with shaft components. However, such a configuration may use additional space in and around the steering column assembly and possibly interfere with passenger movement. In addition, the clamping mechanism may be positioned along the bolt, taking of additional space. Packaging requirements restrict the location of a rake and telescope locking devices.

Accordingly, it is desirable to provide an adjustable steering column having a clamping or locking mechanism on or near a center of the steering column with an actuating lever similarly positioned.

### SUMMARY OF THE INVENTION

According to an exemplary embodiment of the present invention, there is provided an adjustable steering column, adjustable in a rake direction and telescope direction, including a rake bracket having a first leg and a second leg, a steering shaft extending within an upper jacket along a first axis between the first leg and second leg, a lower jacket positioned about the upper jacket and a locking clamp positioned about the lower jacket. The steering column also includes an actuating lever rotatable in a first direction and a second direction, a clamp bolt having a first end with the actuating lever positioned thereon and a second end coupled to the locking clamp, the clamp bolt extending along a second axis that intersects the upper jacket, and a pressing mechanism positioned on the clamp bolt and operable in response to rotation of the actuating lever in the first direction such that the steering shaft is secured against adjustment in the rake direction and telescope direction and the steering shaft is adjustable in the rake direction and telescope direction in response to rotation of the actuating lever in the second direction.

These and other advantages and features will become more apparent from the following description taken in conjunction with the drawings.

### BRIEF DESCRIPTION OF THE DRAWINGS

The subject matter which is regarded as the invention is particularly pointed out and distinctly claimed in the claims at the conclusion of the specification. The foregoing and other features, and advantages of the invention are apparent from the following detailed description taken in conjunction with the accompanying drawings in which:

FIG. 1 is an exploded view of an adjustable steering column according to an exemplary embodiment of the present invention;

FIG. 2 is a front cross-sectional view of an adjustable steering column according to an exemplary embodiment of the present invention; and

FIG. 3 is a top cross-sectional view of an adjustable steering column according to an exemplary embodiment of the present invention.

### DETAILED DESCRIPTION

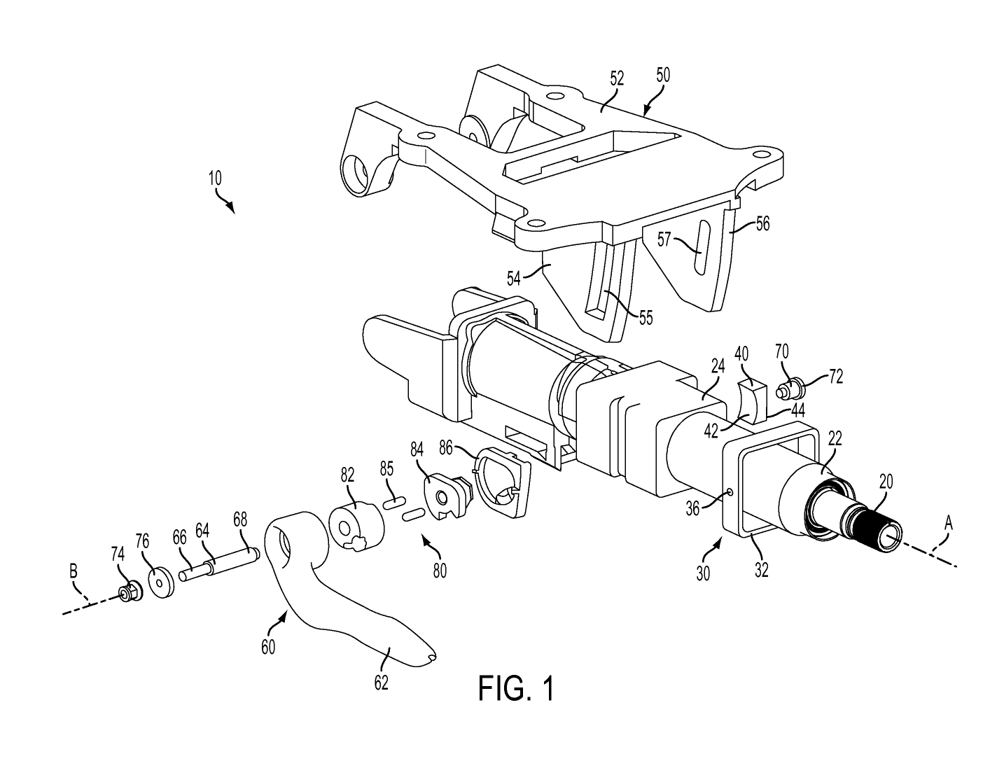

Referring now to the Figures, where the invention will be described with reference to specific embodiments, without limiting same, FIG. 1 is an exploded view of an adjustable steering column 10 according to an exemplary embodiment of the present application. The steering column assembly 10 includes a steering shaft 20 extending along a first axis ‘A’. A steering wheel (not shown) is attached to one end of the steering shaft. Another end of the steering shaft 20 is coupled a steering gear (not shown).

The steering shaft 20 extends within an upper jacket 22. The steering shaft 20 is rotationally supported by and axially retained in the upper jacket 22. In an exemplary embodiment, the upper jacket 22 extends coaxially with the steering shaft 20 and a plurality of bearings (not shown) are disposed between the upper jacket 22 and steering shaft 20.

A lower jacket 24 is positioned about and supports the upper jacket 22. In an exemplary embodiment, the lower jacket 24 may have a generally rectilinear cross section along the first axis ‘A’. The upper jacket 22 extends through the lower jacket 24.

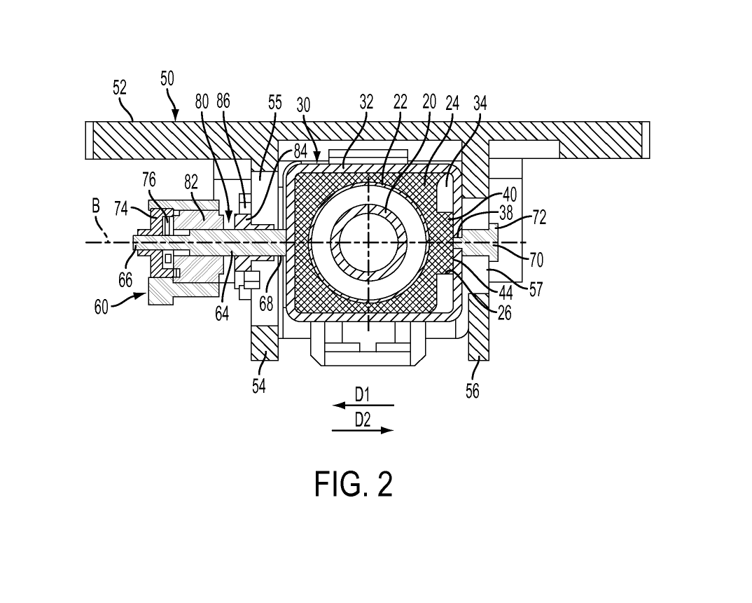

A locking clamp 30 includes a clamp band 32 and a clamp shoe 40. In an exemplary embodiment, clamp band 32 has a generally rectilinear profile to match the profile of the lower jacket 24. The clamp band 32 is configured to extend about an outer periphery of the lower jacket 24 so that the clamp band 32 is generally on center with the lower jacket 24, upper jacket 22 and steering shaft 20. The clamp band 32 is spaced from the lower jacket 24 along one side of the lower jacket 24 to form an operational gap 34 (FIG. 2) between the clamp band 32 and the lower jacket 24. The operational gap 34 allows for movement of the clamp band 32 relative to the lower jacket 24 in a direction perpendicular to the first axis ‘A’. The clamp band 32 also includes a first fastening hole 36 and a second fastening hole 38 (FIG. 2) for attachment to other components of the steering column as described further below.

The clamp shoe 40 is positioned within the clamp band 32 and is configured to engage and selectively apply a first clamping force to the upper jacket 22. The clamp shoe 40 has a pressing face 42 for engaging the upper jacket 22. In an exemplary embodiment, the pressing face 42 has an arcuate profile that matches a profile of the upper jacket 22.

FIG. 2 is a cross section of a front view of the adjustable steering column 10 according to an exemplary embodiment of the present invention. Referring to FIGS. 1 and 2, the adjustable steering column 10 further includes a rake bracket 50. In an exemplary embodiment, the rake bracket 50 includes a mounting section 52, a first leg 54 and a second leg 56. The mounting section 52 is configured to be secured to an adjacent vehicle component by suitable fasteners. In an exemplary embodiment, the mounting section 52 includes at least one opening configured to receive a fastener to be secured to the adjacent vehicle component.

The first leg 54 extends from the mounting section 52. In an exemplary embodiment, the first leg 54 extends generally perpendicularly from the mounting section 52, but is not limited to such a configuration. The second leg 56 is spaced from the first leg 54 and extends from the mounting section 52. In an exemplary embodiment, the second leg 56 extends generally perpendicularly from the mounting section 52 and parallel to the first leg 54. However, it is understood that the present invention is not limited to this configuration, and the second leg 56 may extend from the mounting section 52 at a non-perpendicular angle and may be non-parallel to the first leg 54. The first leg 54 and second leg 56 are spaced apart to receive to the locking clamp 30, the lower jacket 24, the upper jacket 22 and the steering shaft 20 therebetween. A first rake slot 55 is formed in the first leg 54 and a second rake slot 57 is formed in the second leg 56.

With reference to FIG. 2, the lower jacket 24 includes a slot 26. The slot is configured to receive the clamp shoe 40. Accordingly, the clamp shoe is disposed partially within the slot 26 and partially within the operational gap 34 formed between the clamp band 32 and the lower jacket 24. An outer face 44 of the clamp shoe 40 is configured to abut the clamp band 32 while the pressing face 42 is configured to engage the upper jacket 22.

With further reference to FIG. 2, the adjustable steering column 10 also includes an actuating lever 60. The actuating lever 60 includes a handle portion 62 (FIG. 1) and is rotatable about a second axis 13′ and a clamp bolt 64. The clamp bolt 64 extends along the second axis 13′. The second axis 13′ is positioned to intersect the telescope clamp 30. In an exemplary embodiment, the second axis 13′ intersects the first axis ‘A’ of the steering shaft 20. Also, in an exemplary embodiment, the clamp bolt 64 extends along the second axis 13′ through the first leg 54 of the rake bracket 50. Thus, the clamp bolt 64 and actuating lever 60 are on center with the steering shaft 20.

The clamp bolt 64 includes a first end 66 and a second end 68. The actuating lever 60 is positioned at the first end 66. The second end 68 is coupled with the clamp band 32. In an exemplary embodiment, the second end 68 of the clamp bolt 64 is received in the first fastening hole 36 of the clamp band 32 is axially fixed to the clamp band 32. Accordingly, the clamp bolt 64 may exert a pushing or pulling force on the clamp band 32. Similarly, the clamp band 32 may exert a rake adjusting force on the clamp bolt 64 when the steering shaft 20 is adjusted in the rake direction.

A bolt guide 70 is positioned on an opposite side of the locking clamp 30, lower jacket 24, upper jacket 22 and steering shaft 20 from clamp bolt 64. The bolt guide 70 is coupled to the second fastening hole 38 of the clamp band 32 is movable in the second rake slot 57 of the second leg 56 during rake adjustment of the steering shaft 20. The bolt guide 70 also includes a head 72 positioned on an outer side of the second leg 56. The head 72 has a diameter or width greater than a width of the second rake slot 57 so that the head 72 may abut an outer surface of the second leg 56.

Further, an adjusting nut 74 is positioned at the first end 66 of the clamp bolt 64. The adjusting nut 74 is threadably coupled to the clamp bolt and may be adjusted in a direction along the second axis 13′ by rotating along the clamp bolt 64. The adjusting nut 74 may be used to adjust or remove lash, i.e., gaps between parts along the clamp bolt 64 resulting from part-to-part variations, or in some cases, apply a preload along clamp bolt 64 thereby adjusting a clamping force. A thrust bearing 76 may be positioned on the clamp bolt 64 adjacent to the adjusting nut 74.

During adjustment of the steering shaft 20 in the rake direction, the clamp band 32, clamp shoe 40, lower jacket 24, upper jacket 22 and steering shaft 20 are movable relative to the rake bracket 50 in the rake direction. The clamp bolt 64 is movable in the first rake slot 55 of the first leg 54 and the guide bolt 70 is movable in the second rake slot 57 of the second leg 56. During adjustment in the telescope direction, the steering shaft 20 and upper jacket 22 are movable in the telescope direction relative to the lower jacket 24, clamp band 32, clamp shoe 40 and rake bracket 50.

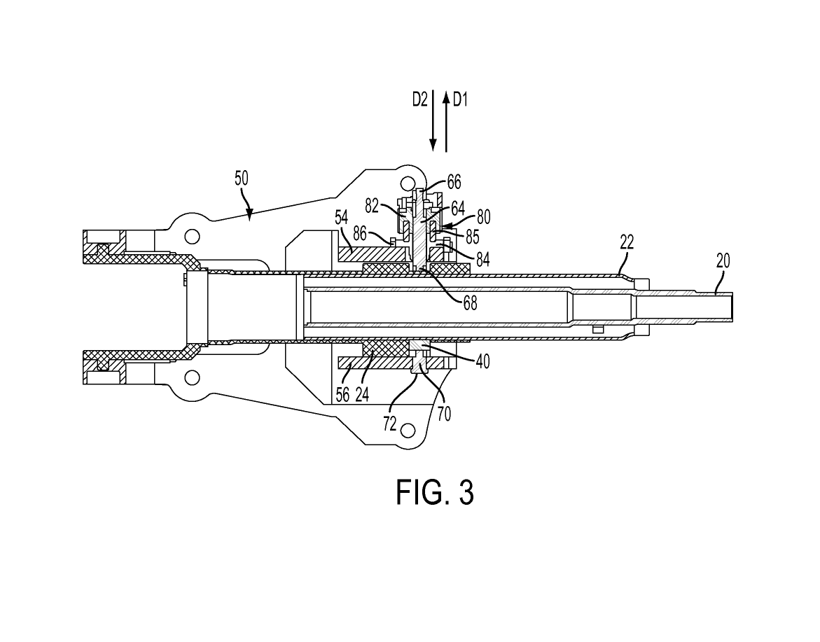

FIG. 3 is a cross section top view of the adjustable steering column 10 according to an exemplary embodiment of the present invention. With reference to FIGS. 1-3, the adjustable steering column 10 further includes a pressing device 80 configured to selectively apply a second clamping force on the rake bracket 50, and in turn, the lower jacket 24. In an exemplary embodiment, the second clamping force is applied via the first leg 54 of the rake bracket 50 to the lower jacket 24 to secure the lower jacket 24, and in turn, the locking clamp 30, upper jacket 22 and the steering shaft 20 against movement in the rake direction relative to the rake bracket 50. Thus, when the second clamping force is applied, the steering shaft 20 is secured against adjustment in the rake direction. The lower jacket 24, locking clamp 30, upper jacket 22 and steering shaft 20 are movable in the rake direction between the first and second legs 54, 56 when the second clamping force is released. Accordingly, with the second clamping force released, the steering shaft 20 may be adjusted in the rake direction.

In an exemplary embodiment, the pressing device 80 is a cam mechanism comprising a first cam part 82 and second cam part 84. The first and second cam parts 82, 84 are positioned on the clamp bolt 64. One of the cam parts is rotatable relative to the other. Relative rotation between the cam parts 82, 84 causes one cam part to move axially away or toward the other cam part, thereby applying or releasing the second clamping force to the rake bracket 50. In some instances, both cam parts 82, 84 may be axially movable along the clamp bolt 64.

In an exemplary embodiment, the first cam part 82 is positioned within the actuating lever 60 and coupled to the actuating lever 60 such that the first cam part 82 rotates with the actuating lever 60 in a first and a second direction relative to the clamp bolt 64, and is slidable in the axial direction along the clamp bolt 64. Rotation of the actuating lever 60 in the first direction causes the first cam part 82 and second cam part 84 to move axially away from each other. This movement causes the second cam part 84 to apply the second clamping force to the first leg 54 of the rake bracket 50. In turn, the second clamping force is applied from the first leg 54 to the lower jacket 24, and to the second leg 56 via the lower jacket 24. Rotation of the actuating lever 60 in the second direction, opposite to the first direction, causes first cam part 82 and second cam part 84 to move axially toward one another and release the second clamping force. The first cam part 82 and second cam part 84 are urged toward each other due to resiliency in the components arranged along the clamp bolt 64 and the second clamping force applied between the components. A cam guide 86 may be positioned along the clamp bolt 64. The cam guide 86 is coupled to the second cam part 84 to secure the second part 84 against rotation.

Further, in an exemplary embodiment, the relative axial movement between the first cam part 82 and second cam part 84 causes the first cam part 82 to move in an outward direction ‘D1’ in response to rotation of the actuating lever 60 in the first direction and an inward direction ‘D2’ in response to rotation of the actuating lever 60 in the second direction. The first cam part 82 is coupled to the actuating lever and slides axially along the clamp bolt 64. Movement of the first cam part in the directions ‘D1’ and ‘D2’ may cause the clamp bolt 64 to move in the outward direction ‘D1’ and inward direction ‘D2’ as well.

In an exemplary embodiment, and with reference to FIG. 3, the cam mechanism of the pressing device 80 may be a pin-type cam. In a pin-type cam, at least one pin 85, and preferably at least two pins, is disposed in respective recesses of the first cam part 82 and second cam part 84. In a first position, the at least one pin 85 is angled relative to the second axis ‘B’, thereby reducing or minimizing an axial distance between the first cam part 82 and second cam part 84. Rotation of one cam part relative to the other (in response to rotation of the lever 60) causes the at least one pin 85 to move within the respective recesses toward a position that is generally parallel with the second axis ‘B’. During this movement, the at least one pin 85 pushes the first cam part 82 and second cam part 84 axially away one another. This movement causes the second clamping force to be applied to the first leg 54 of the rake bracket 50.

It is understood that the cam mechanism of the pressing device 80 is not limited only to a pin-type cam, and that other suitable cams are envisioned. For example, other cam mechanisms that apply an axial clamping force to, or release the axial clamping from, the rake bracket 50, and in turn, to the lower jacket 24 in response to rotation of the lever 60 may be used as well. As non-limiting examples, the first and second cam parts may include a number of projections and recesses interfacing with and rotatably slidable relative to one another such that when peaks of respective projections are in contact with one another the axial clamping force is applied, and when a projection of one cam part is positioned within a recess of another cam part the axial clamping force is released.

In operation, and with reference to FIGS. 1-3, the actuating lever 60 is rotated in a first direction to secure the steering shaft 20 against adjustment in both the rake and telescope directions. Rotation of the actuating lever 60 in the first direction operates the pressing device 80. In an exemplary embodiment, the first cam part 82 rotates together with the actuating lever 60 and relative to the second cam part 84. Relative rotation between the first cam part 82 and second cam part 84 causes the first and second cam parts 82, 84 to move axially apart from each other.

The second cam part 84 pushes against the first leg 54 to apply the second clamping force while the first cam part 82 is urged axially away from the second part 84. Movement of the first cam part 82 away from the second cam part 84 may cause the clamp bolt 64 to move axially along the second axis ‘B’ in an outward direction ‘D1’ due to the relative configuration of the first cam part 82, actuating lever 60 and clamp bolt 64. For example, the actuating lever 60 may be axially fixed relative to the clamp bolt 64. Accordingly, axial movement of the first cam part 82 against the actuating lever 60 may apply a force to the actuating lever 60 that also acts on the clamp bolt 64 to move the clamp bolt 64 in the outward direction ‘D1’. The second end 68 of the clamp bolt 64 pulls the clamp band 32 in the outward direction along the second axis 13′. In turn, the clamp band 32 pulls the clamp shoe 40 against the upper jacket 22 to apply the first clamping force. Further, the clamp shoe 40 pushes the upper jacket 22 against the lower jacket 24 on a side of the upper jacket 22 opposite to the clamp shoe 40. The upper jacket 22 acts on the lower jacket 24 to push the lower jacket 24 into contact with the first leg 54 of the rake bracket 50.

The upper jacket 22 is clamped between the clamp shoe 40 and the lower jacket 24. The clamp shoe 40 applies the first clamping force to the upper jacket 22 while a reaction is applied to the upper jacket 22 on an opposite side by the lower jacket 24. In this condition, the upper jacket 22 and the steering shaft 20 extending therein are secured against movement in the telescope direction. Thus, the steering shaft 20 is secured against adjustment in the telescope direction.

In addition, the second clamping force is applied to the first leg 54 by the pressing device 80, and in an exemplary embodiment, by the second cam 84. The second clamping force is applied to the lower jacket 24 via the first leg 54. In response to rotation of the actuating lever 60 in the first direction, the guide bolt 70 pulls on the second leg 56 of the rake bracket 50 via the head 72 of the guide bolt on an outer side of the second leg 56. Thus, the lower jacket 24 is clamped between the first leg 54 and second leg 56. In this condition, the lower jacket 24, and thus, the upper jacket 22 and steering shaft 20 are secured against movement in the rake direction relative to the rake bracket 50. Thus, the steering shaft 20 is also secured against adjustment in the rake direction.

The steering shaft 20 may be adjusted by rotating the actuating lever 60 in a second direction, opposite to the first direction. Rotation of the actuating lever 60 in the second direction causes the first cam part 82 and second cam part 84 to move axially towards one another due to rotation of the first cam part 82 with the actuating lever 60. This releases the second clamping force applied to the first leg 54 of the rake bracket and allows the first cam part 82 to slide along the axis of the clamp bolt 64 in an inward direction ‘D2’. Movement of the first cam part 82 in the inward direction ‘D2’ may also allow the clamp bolt 64 to move in the inward direction ‘D2’.Rotation of the actuating lever 60 causes the clamp band 32 to release a force applied to the clamp shoe 40, thereby releasing the first clamping force. As a result, the upper jacket 22 is released from clamping engagement between the lower jacket 24 and the clamp shoe 40. In this condition, the upper jacket 22 and steering shaft 20 are movable relative to the lower jacket 24, and thus, the steering shaft 20 may be adjusted in the telescope direction.

Further, the lower jacket 24 is released from clamping engagement between the first leg 54 and second leg 56. In this condition, the lower jacket 24, and thus, the upper jacket 22 and steering shaft are movable in the rake direction relative to the rake bracket 50. Accordingly, the steering shaft 20 may be adjusted in the rake direction.

The configurations described in the exemplary embodiments above are non-limiting, and it is understood that other configurations are envisioned as well. For example, the clamp shoe 40 may be omitted and the clamp 32 may interface direction with the upper jacket 22 during operation.

In the exemplary embodiments above, the locking clamp 30 may be easily formed as a simple extrusion. In addition, the clamp shoe 40 may be formed as an easy to manufacture geometric shape. Further, the adjusting nut 74 may adjust clamping loads in the adjustable steering column. Further still, the adjustable steering column 10 described above incorporates relatively few components so that manufacturing may be simplified and assembly times may be decreased.

While the invention has been described in detail in connection with only a limited number of embodiments, it should be readily understood that the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description.

Having thus described the invention, it is claimed:

1. An adjustable steering column, adjustable in a rake direction and telescope direction, comprising:
a rake bracket having a first leg and a second leg;
a steering shaft extending within an upper jacket along a first axis between the first leg and second leg;
a lower jacket positioned about the upper jacket;
a locking clamp positioned about the lower jacket;
an actuating lever rotatable in a first direction and a second direction;
a clamp bolt having a first end with the actuating lever positioned thereon and a second end coupled to the locking clamp, the clamp bolt extending along a second axis that intersects the upper jacket; and
a pressing mechanism positioned on the clamp bolt and operable in response to rotation of the actuating lever in the first direction such that the steering shaft is secured against adjustment in the rake direction and telescope direction and the steering shaft is adjustable in the rake direction and telescope direction in response to rotation of the actuating lever in the second direction.

2. The adjustable steering column of claim 1, where in the second axis intersects the first axis.

3. The adjustable steering column of claim 1, wherein the locking clamp includes a clamp band extending about the lower jacket.

4. The adjustable steering column of claim 3, wherein the locking clamp further includes a clamp shoe positioned between the clamp band and the lower jacket.

5. The adjustable steering column of claim 1, wherein the first leg comprises a first rake slot and the second leg comprises a second rake slot, the clamp bolt extending through the first rake slot along a second axis that intersects the upper jacket.

6. The adjustable steering column of claim 5, wherein the pressing mechanism comprises a first cam part rotatable with the actuating lever and a second cam part configured to apply or release a bracket clamping force to the first leg of the rake bracket in response to rotation of the actuating lever.

7. The adjustable steering column of claim 6, wherein first cam part is connected to the actuating lever such that in response to rotation of the actuating lever in the first direction, the first cam part moves axially away from the second cam part in an outward direction and the second cam part applies the bracket clamping force to first leg.

8. The adjustable steering column of claim 7, wherein the locking clamp moves in the outward direction and applies a jacket clamping force to the upper jacket in response to movement of the clamp bolt in the outward direction.

9. The adjustable steering column of claim 8, wherein the locking clamp comprises a clamp band and a clamp shoe, the clamp band pressing the clamp shoe against the upper jacket to apply the jacket clamping force in response to movement of the clamp bolt in the outward direction.

10. The adjustable steering column of claim 9, wherein the second axis intersects the first axis.

11. The adjustable steering column of claim 9, further comprising a guide bolt connected to the clamp band and extending through the second slot, wherein the second cam part is configured to apply the bracket clamping force to the first leg and the guide bolt is configured to act on the second leg to clamp the lower jacket between the first leg and second leg in response to movement of the clamp bolt in the outward direction.

12. The adjustable steering column of claim 1, further comprising an adjusting nut threadably coupled to the first end of the clamp bolt, the adjusting nut movable along the clamp bolt to adjust a clamping pre-load.
